(19) United States
(12) Patent Application Publication
(10) Pub. No.: US 2023/0333544 A1
(43) Pub. Date: Oct. 19, 2023

(54) SYSTEM AND METHOD FOR PLANNING INTEGRATED VEHICLE PRODUCTION

(71) Applicants: HYUNDAI MOTOR COMPANY, Seoul (KR); KIA CORPORATION, Seoul (KR)

(72) Inventors: Seung Hyeon Kim, Goyang-si (KR); Kyu Hyun Hwang, Seoul (KR)

(73) Assignees: HYUNDAI MOTOR COMPANY, Seoul (KR); KIA CORPORATION, Seoul (KR)

(21) Appl. No.: 17/978,792

(22) Filed: Nov. 1, 2022

(30) Foreign Application Priority Data
Apr. 15, 2022 (KR) 10-2022-0046757

(51) Int. Cl. G05B 19/418

(52) U.S. Cl. CPC G05B 19/41865; G05B 2219/31053

(57) ABSTRACT

An integrated production planning system of a vehicle includes an information storage unit configured to accumulate and store basic information and work history information of each of a plurality of workers, the work history information including a type of a work performed by the worker in the past and required time for the work. The integrated production planning system also includes a production plan establishment unit configured to establish a vehicle production plan constituted of a work type and a work sequence, to calculate expected hours required for work for each worker based on the basic information and work history information for each worker of the information storage unit, and to establish the vehicle production plan or modify a previously generated production plan by reflecting the calculated expected hours required for the work.

### CROSS-REFERENCE TO RELATED APPLICATION(S)

This application is based on and claims priority under U.S.C. 119 to Korean Patent Application No. 10-2022-0046757, filed on Apr. 15, 2022, in the Korean Intellectual Property Office, the disclosure of which is incorporated by reference herein in its entirety.

### BACKGROUND OF THE DISCLOSURE

### 1. Field of the Disclosure

The disclosure relates to a system and a method for planning integrated vehicle production and, more specifically, to a system and a method for planning integrated vehicle production, where a vehicle production plan is established on the basis of basic information and work history information of each of multiple workers who work in a vehicle manufacturing factory. Thus, a realistic production plan, and more specifically a production plan that reflects a change in the working environment in real time, is established, thereby actively coping with various environment changes and improving reliability.

### 2. Description of the Prior Art

A large amount of reference information is necessary to establish a vehicle production plan in a vehicle manufacturing factory. The working time, among the reference information, is considered the most basic and important part.

A vehicle production plan may be established based on the time necessary to produce components, the order in which components are introduced, movements of components inside production lines, and the like, and based on the working time necessary in each factory.

If there is a large difference between the expected time necessary for work and the actual time necessary for work, the amount (i.e., number) of vehicles produced and the ratio of vehicles delivered to customers within due dates vary. Thus, it is considered a critical issue to accurately calculate the time necessary for work.

Conventional vehicle production planning systems measure the working time through various methods by capturing images through cameras or the like, but the working time may change frequently due to a change in the working environment (for example, worker replacement). In addition, it is difficult to distinguish operations performed by respective workers in an accurate and detailed manner, and workers may be controlled by supervisors subjectively. As a result, there may be a problem in that there is difficulty in accurately measuring the working time.

Therefore, there is a need for a scheme or method for establishing a vehicle production plan by calculating a predicted time necessary for work such that the difference between the expected time necessary for work and the actual time necessary for work is reduced.

The above description regarding background technologies has been made only to enhance understanding of the background of the disclosure. The above description is not to be deemed by those of ordinary skill in the art to correspond to already-known prior art.

### SUMMARY

The disclosure may provide a system and a method for planning integrated vehicle production, where a vehicle production plan is established on the basis of basic information and work history information of each of multiple workers who work in a vehicle manufacturing factory. Thus, a realistic production plan, and more specifically a production plan that reflects a change in the working environment in real time, is established, thereby actively coping with various environment changes and improving reliability.

In accordance with an aspect of the disclosure, an integrated vehicle production planning system includes: an information storage unit configured to accumulate and store basic information and work history information of each of a plurality of workers, the work history information including a type of a work performed by each of the plurality of workers in the past and required time for the work; and a production plan establishment unit configured to establish a vehicle production plan constituted of a work type and a work sequence, to calculate expected hours required for work for each worker of the plurality of workers based on the basic information and work history information for each worker of the information storage unit, and to establish the vehicle production plan or modify a previously generated production plan by reflecting the calculated expected hours required for the work.

The basic information of a respective worker of the plurality of workers may include at least one of a height, gender, and career of the respective worker.

The work type may include at least one of a past production item, a production line, and a production time period of the worker.

The production plan establishment unit may repeatedly establish the vehicle production plan and may reflect the expected hours required for the work for each worker updated for every establishment of the vehicle production plan.

When the basic information and work history information of each of the plurality of workers are changed, the production plan establishment unit may modify the previously generated production plan.

The production plan establishment unit may calculate the expected hours required for the work of each worker according to a vehicle model or mounting option, and may reflect the calculated worker's expected hours required for work to establish the overall vehicle production plan or to revise the previously generated production plan.

The production plan establishment unit may receive the basic information and work history information for each worker to calculate the expected hours required for the work for each worker through data mining.

The information storage unit may accumulate and store the basic information and work history information of each of the plurality of workers through an enterprise resource planning (ERP) system, and the production plan establishment unit may establish the vehicle production plan by reflecting the expected hours required for the work through an advanced planning and scheduling (APS) system.

When vehicle production is completed according to the established vehicle production plan, the production plan establishment unit may transmit the modified basic information and work history information of each of the plurality of workers after the completion.

In accordance with another aspect of the disclosure, an integrated vehicle production planning method includes: accumulating and storing basic information and work history information of each of a plurality of workers by an information storage unit; establishing a vehicle production plan consisting of a type of work and a work sequence by a production plan establishment unit; calculating an expected hours required for work for each worker of the plurality of workers based on the basic information and work history information of each worker of the information storage unit by the production plan establishment unit; and establishing a vehicle production plan by reflecting the calculated expected hours required for work by the production plan establishment unit.

The method may further include, after the establishing of the vehicle production plan by the production plan establishment unit, modifying a previously generated production plan when the basic information and work history information for each worker of the plurality of workers are changed.

The method may further include, after the establishing of the vehicle production plan by the production plan establishment unit, transmitting the changed basic information and work history information for each worker of the plurality of workers to the information storage unit when the vehicle production is completed according to the established vehicle production plan.

The calculating of the expected hours required for the work for each worker by the production plan establishment unit may include repeatedly establishing the vehicle production plan by the production plan establishment unit, and reflecting the expected hours required for the work for each worker updated every establishment of the vehicle production plan.

According to a system and a method for planning integrated vehicle production of the disclosure, a vehicle production plan is established based on basic information and work history information of each of multiple workers who work in a vehicle manufacturing factory. Thus, a realistic production plan, and more specifically a production plan that reflects a change in the working environment in real time, is established, thereby actively coping with various environment changes and improving reliability.

Advantageous effects obtainable from the present disclosure are not limited to the above mentioned effects. Other effects which are not mentioned above should be clearly understood, through the following descriptions, by those of ordinary skill in the art to which the present disclosure pertains.

### BRIEF DESCRIPTION OF THE DRAWINGS

The above and other aspects, features and advantages of the present disclosure should be more apparent from the following detailed description taken in conjunction with the accompanying drawings, in which:

FIG. 1 is a diagram illustrating the configuration of an integrated production planning system of a vehicle according to an embodiment of the disclosure;

FIG. 2 is a diagram illustrating an information collection/management method of an information storage unit in which basic information and work history information of each of a plurality of workers are stored;

FIG. 3 is a schematic diagram illustrating a process of calculating expected hours required for work for each worker through data mining of a production plan establishment unit; and

FIG. 4 is a flowchart in which the integrated production planning system of the vehicle according to FIG. 1 is operated.

### DETAILED DESCRIPTION

Hereinafter, embodiments disclosed in the present specification are described in detail with reference to the accompanying drawings. The same or similar elements are given the same and similar reference numerals, so duplicate descriptions thereof are omitted. The terms “module” and “unit” used for the elements in the following description are given or interchangeably used in consideration of only the ease of writing the specification, and do not have distinct meanings or roles by themselves. In addition, in relation to describing the embodiments disclosed in the present specification, when a detailed description of the relevant known technology is determined to unnecessarily obscure the gist of the present disclosure, a detailed description thereof is omitted. Further, the accompanying drawings are provided only to enhance understanding of the embodiments disclosed in the present specification. The technical spirit disclosed herein is not limited to the accompanying drawings, and it should be understood that all changes, equivalents, or substitutes thereof are included in the spirit and scope of the present disclosure.

Terms including an ordinal number such as “first”, “second”, or the like may be used to describe various elements, but the elements are not limited to the terms. The above terms are used only for the purpose of distinguishing one element from another element.

In the case where an element is referred to as being “connected” or “coupled” to any other element, it should be understood that another element may be provided therebetween, as well as that the element may be directly connected or coupled to the other element. In contrast, in the case where an element is “directly connected” or “directly coupled” to any other element, it should be understood that no other element is present therebetween.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

In general, a predetermined time standard system (PTS) method is the most popularly used method of establishing a vehicle production plan by predicting the standard time without measuring the working hours when a new factory is built, a product is input, or a new work or task occurs.

Examples of the PTS method include motion time analysis (MTA), methods time measurement (MTM), modular arrangement of predetermined time standards (MODAPTS), and the like, and among them, MODAPTS is the most used. Calculation of working hours through MODAPTS gives standard time for detailed human motions, and standard working hours are calculated in consideration of a combination of the detailed motions and the skill level of the worker involved. However, this method of calculating the working hours has a chronic problem in that the calculated working hours are slightly different from actual working hours because the method does not take into account the diversity of various workers' height, gender, body type, physical strength, and the like, and the characteristics of each job. Due to such a problem, there is no choice but to show or have a difference between the production plan and the actual production performance.

Accordingly, the disclosure proposes a production planning system for realizing minimization of a gap or difference between a production plan capable of solving the above problem and the actual production performance.

An integrated production planning system of a vehicle according to the disclosure is a system for establishing a vehicle production plan based on required actual working hours. The disclosed integrated production planning system aims to establish a highly reliable production plan that calculates expected work hours reflecting a daily changing production environment and minimizes a gap between the production plan and the performance by reflecting the calculated expected work hours.

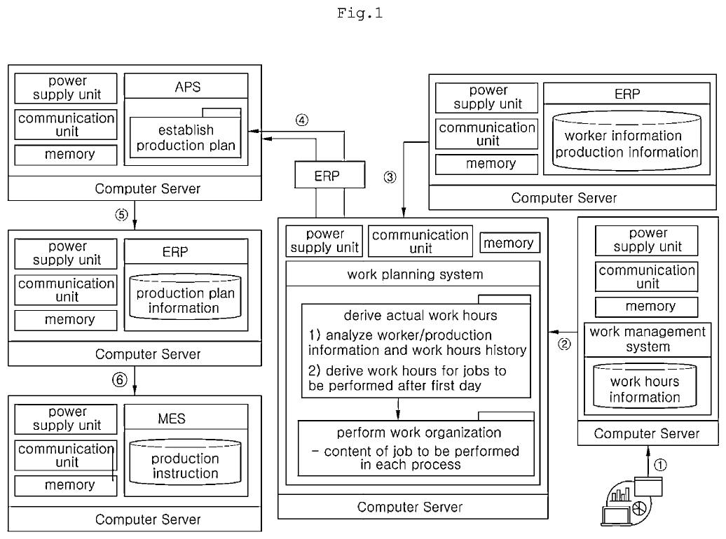

In general, the integrated production planning system of the vehicle in the disclosure may include an information storage unit and a production plan establishment unit for establishing a production plan. Referring to FIG. 1, the information storage unit may include a work management system and a work planning system, The work management system and work planning system may accumulate and store basic information and work history information of each of a plurality of workers through an enterprise resource planning (ERP) system. The ERP system for allowing the basic information and the work history information to be accumulated and stored in the information storage unit is provided as an example and the present disclosure is not necessarily limited thereto. Various systems may be included as a system for storing information. For example, the ERP system may receive the production plan of the vehicle established in the production plan establishment unit.

In addition, the production plan establishment unit may include a work organization system that receives the basic information and work history information of each of the plurality of workers from the information storage unit and organizes the work. The work organization system may establish a vehicle production plan by reflecting expected hours required for the work through an advanced planning and scheduling (APS) system. As described in the information storage unit, the APS system for establishing the vehicle production plan by reflecting the expected hours required for the work in the production plan establishment unit is provided as an example and the present disclosure is not necessarily limited thereto. The APS system is a system for calculating the expected hours required for the work and establishing the vehicle production plan, and various systems may be included.

In summary, as illustrated in FIG. 1, the work management system may measure the work hours from the workers and collect basic information and work history information of each of the plurality of workers. The work planning system may accumulate and store the basic information and work history information of each of the plurality of workers from the ERP system and the work management system.

Thereafter, expected hours required for the work for each work project (e.g., task, action, and the like) may be calculated through data mining performed on the stored basic information and work history information of each of the plurality of workers. Through this, it is possible to establish a production plan for production after the first day based on the calculated expected work hours for each worker.

After the vehicle production plan is established, a manufacturing execution system (MES) may receive the production plan established and revised by the production plan establishment unit and may control the system so that the vehicle is manufactured according to the production plan.

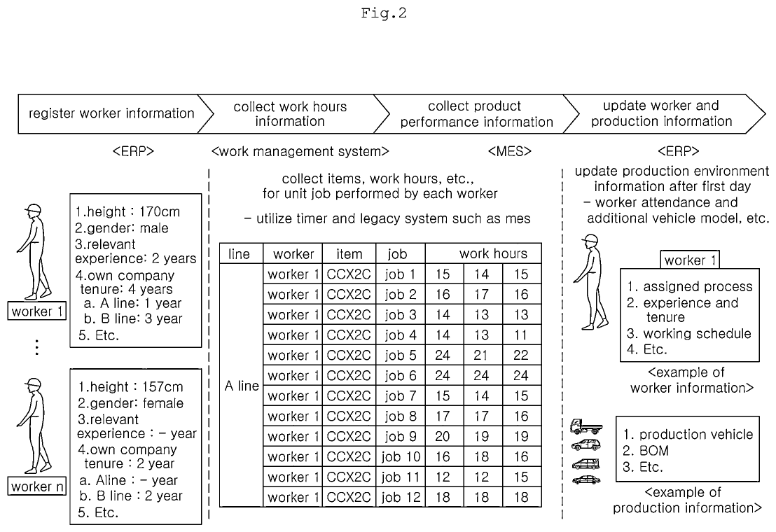

The information storage unit of the above-described integrated vehicle production planning system is described with reference to FIG. 2.

FIG. 2 is a diagram illustrating an information collection/management method of an information storage unit in which basic information and work history information of each of a plurality of workers are stored.

The information storage unit may accumulate and store basic information and work history information of each of the plurality of workers. The worker's basic information may include the worker's height, gender, and experience. In addition, the basic information of the worker may include a body type, physical strength, and the like, of the worker in addition to the height, gender, and experience.

The establishment of the production plan by the production plan establishment unit based on the basic information of the worker can be made as follows. For example, when it is determined that the height of a worker is lower than the average, the vehicle production plan may be established so that a worker having a height higher than average is deployed to an important job to shorten the expected work hours. However, when it is determined that the height of the worker is lower than the average, when the worker having a height lower than the average is absolutely necessary although it is unlikely that the worker having a height lower than average will be deployed to an important job, the expected hours required for the work may be increased so that a realistic production plan may be established by reflecting the actual production capacity of the factory.

In addition, when the gender of the worker is male, the worker may be deployed to a job that requires the worker's physical strength, so that the vehicle production plan may be established to shorten the expected hours required for the work. Similarly, it may be determined that the more experience a worker has in a specific job, the higher the ability to perform the work for the specific job, so that the vehicle production plan may be established to shorten the expected hours required for the work.

In addition, the work history information may include the type of work performed by the worker in the past and the time required for the work. The work type may include the worker's past production items, production line, and production time period.

For example, when it is determined that the worker's past production item is the same as an item to be produced by the worker or the production line is the same, it may be determined that the worker's experience is high so that the production plan establishment unit may establish the vehicle production plan to shorten the expected hours required for the work.

In addition, when it is determined that the time of the worker's work on the production line in the past is early morning and the time required for the work performed at dawn is shortened, it is determined that the worker's ability to perform the work at dawn is high, so that the vehicle production plan may be established by inputting the worker at dawn to shorten the expected hours required for the work.

In the case of the time required by the worker for the job, as illustrated in FIG. 2, the required time for the job may be collected by utilizing a legacy system such as a timer and an MES for a unit job performed by each worker. In this example, when the work hours of a specific worker are different for each job in some cases, the work hours may be summed up, and a value obtained by dividing the summed work hours by the number of jobs may be defined as the time required for each job.

When a job requires a plurality of workers, the production plan establishment unit may calculate the expected hours required for the work based on only the basic information and work history information of each worker, and then may calculate the expected hours required for the work of the plurality of workers again. Alternatively, based on the accumulated and stored basic information and work history information of each of the plurality of workers, it is also possible to calculate the expected hours required for the work considering the synergy between the workers.

Hereinafter, the production plan establishment unit that calculates the expected hours required for the work based on the basic information and work history information for each worker of the information storage unit is described.

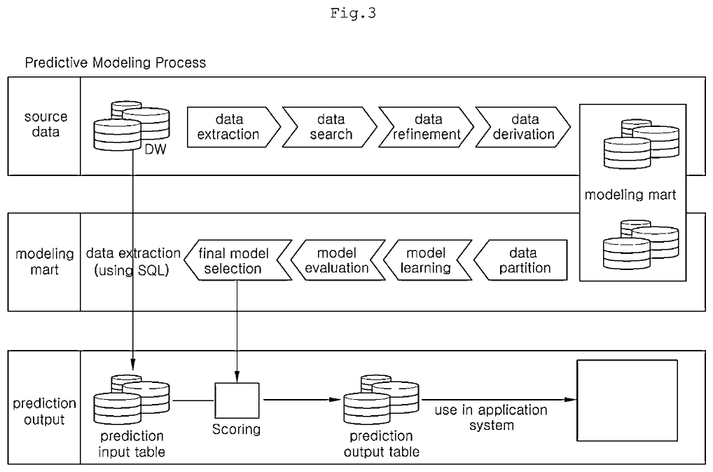

The calculation of the expected work hours required for each worker of the production plan establishment unit is described with reference to FIG. 3. FIG. 3 is a schematic diagram illustrating a process of calculating expected hours required for work for each worker through data mining of a production plan establishment unit. The production plan establishment unit may receive basic information and work history information for each worker and may calculate expected hours required for work for each worker through data mining.

The data mining technique is to extract valuable information by systematically and automatically analyzing statistical rules or patterns from large-scale stored data and may include supervised learning and unsupervised learning. In other words, the production plan establishment unit may analyze the influence of variables including the worker's height, gender, experience, the worker's past production items, production line, production time period, and time required for work on the work required time and may automatically analyze the statistical rules or patterns of the variables to learn a model. Through the learned model, it is possible to specifically calculate the expected hours required for the work for each worker based on the basic information and work history information for each worker.

More specifically, as illustrated in FIG. 3, data including the worker's height, gender, experience, the worker's past production items, production line, production time period, and time required for work may be extracted from the information storage unit. A process of exploring, refining, and deriving data may proceed through source data. Thereafter, a final model may be selected based on a process of dividing data and learning and evaluating the model. The evaluated model, and a final result value (in the disclosure, the expected hours required for the work), may be obtained through the data extracted from the source data.

In addition, the production plan establishment unit may repeatedly establish the vehicle production plan and may reflect the expected hours required for the work for each worker updated for each establishment of the vehicle production plan. It is necessary to repeatedly establish a production plan in order to establish a production plan for a vehicle reflecting expected hours required for work that reflects the daily changing production environment. A production plan may be established realistically according to the periodic production plan establishment, and reliability may also be secured in the production plan by minimizing a gap between the production plan and the expected production performance.

In another embodiment, the production plan previously generated in the production plan establishment unit may be modified when the basic information and work history information of each of the plurality of workers are changed.

For example, in order to reflect the daily changing production environment, such as some of the plurality of workers being replaced or the career or experience increasing according to the worker's work progress, the production plan generated in advance may be modified after the first day the production plan is established, so that the reliability of production plan establishment may be improved by establishing the production plan in which changes in the environment are reflected in real time.

In another embodiment, the production plan establishment unit may calculate the expected hours required for the work of the worker according to the vehicle model or mounting option (e.g., of a vehicle part) and may establish the entire vehicle production plan or may modify the previously generated production plan by reflecting the calculated worker's expected hours required for work. For example, when the vehicle model is added or the mounting option according to a customer order is added, the expected hours required for the work of the operator may vary. Therefore, when the vehicle model or mounting option information is added before the production plan establishment unit receives the basic information and work history information for each worker, the basic information and work history information for each worker may be modified in real time to calculate the expected hours required for the work based on the modified basic information and work history information for each worker. In addition, when the vehicle model or mounting option information is added after the vehicle production plan has already been established by receiving the basic information and work history information for each worker, it is possible to actively respond to various environmental changes by modifying the previously generated production plan.

The production plan establishment unit may transmit the changed basic information and work history information of each of the plurality of workers to the information storage unit when vehicle production is completed through the production management system according to the established vehicle production plan. The worker's basic information and work history information may be changed through the production plan established periodically or may be changed according to the change of the worker's basic information and work history information such as worker replacement. Therefore, it is possible to actively respond to various environmental changes as described above by establishing the production plan in which changes in the working environment are reflected in real time.

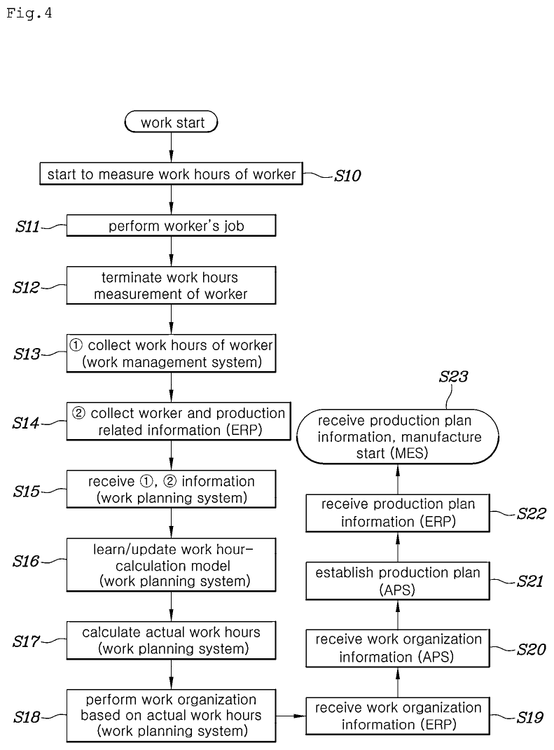

An integrated production planning method of a vehicle according to an embodiment based on the configuration of the above-described integrated production planning system of the vehicle is described with reference to FIG. 4.

FIG. 4 is a flowchart in which the integrated production planning system of the vehicle according to FIG. 1 is operated.

First, a work management system may start measuring work hours from a worker in operation S10. The worker performs a job in operation S11, and the work management system may end the measuring of the work hours of the worker according to the end of the job in operation S12.

Next, the work management system may collect basic information and work history information of each of a plurality of workers in operation S13. A work planning system may accumulate and store the basic information and work history information of each of the plurality of workers from an ERP system and the work management system in operations S14 and S15.

Next, expected hours required for work for each worker may be calculated through data mining performed on the stored basic information and work history information of each of the plurality of workers in operations S15-S17, whereby a production plan for production after the first day may be established based on the calculated expected hours required for work for each worker in operation S21.

In operation S21 of establishing the production plan for production, the work may be organized based on the expected hours required for the work in operation S18, the ERP system may receive work organization information in operation S19, the APS system may receive the work organization information received by the ERP system again in operation S20, and then the production plan may be established in operation S21.

After the vehicle production plan is established, an enterprise resource planning (ERP) system may receive the production plan established and modified by the production plan establishment unit in operation S22.

Also, the manufacturing execution system (MES) may receive the production plan established and modified by the production plan establishment unit, and a system may be controlled so that the vehicle may be manufactured according to the production plan in operation S23.

An integrated production planning method of a vehicle may include accumulating and storing basic information and work history information of each of a plurality of workers by an information storage unit, establishing a vehicle production plan consisting of the type of the work and the work sequence by a production plan establishment unit, calculating an expected hours required for work for each work project (i.e., work to be performed) based on the basic information and work history information of each worker of the information storage unit by the production plan establishment unit, and establishing a vehicle production plan by reflecting the calculated expected hours required for work by the production plan establishment unit.

Detailed technical characteristics in each operation of the method for integrated production planning of a vehicle according to the disclosure are the same as or similar to the technical characteristics of each configuration in the integrated production planning system of the vehicle according to the disclosure described above, and thus a detailed description thereof is omitted.

After the establishing of the vehicle production plan by the production plan establishment unit, when the basic information and work history information for each worker of the plurality of workers are changed, the production plan establishment unit may modify the previously generated production plan.

After the establishing of the vehicle production plan by the production plan establishment unit, when the vehicle production is completed according to the established vehicle production plan, the production plan establishment unit may transmit the changed basic information and work history information for each worker of the plurality of workers to the information storage unit.

The present disclosure as described above may be implemented as codes in a computer-readable medium in which a program is recorded. The computer-readable medium includes all types of recording devices in which data readable by a computer system are stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device, and the like. Further, the above detailed description should not be construed in a limiting sense, but should be considered in an illustrative sense in all aspects. The scope of the present disclosure should not be determined merely by reasonable interpretation of the appended claims. All changes and modifications within the equivalent scope of the present disclosure fall within the scope of the present disclosure.

What is claimed is:

1. An integrated vehicle production planning system comprising:
an information storage unit configured to accumulate and store basic information and work history information of each of a plurality of workers, the work history information including a type of work performed by each of the plurality of workers in the past and required time for the work; and
a production plan establishment unit configured to establish a vehicle production plan constituted of a work type and a work sequence, to calculate expected hours required for work for each worker of the plurality of workers based on the basic information and work history information for each worker of the information storage unit, and to establish the vehicle production plan or modify a previously generated production plan by reflecting the calculated expected hours required for the work.

2. The integrated vehicle production planning system of claim 1, wherein the basic information of a respective worker of the plurality of workers includes at least one of a height, gender, and career of the respective worker.

3. The integrated vehicle production planning system of claim 1, wherein the work type includes at least one of a past production item, a production line, and a production time period of at least one worker of the plurality of workers.

4. The integrated vehicle production planning system of claim 1, wherein the production plan establishment unit repeatedly establishes the vehicle production plan, and reflects the expected hours required for the work for each worker updated for every establishment of the vehicle production plan.

5. The integrated vehicle production planning system of claim 1, wherein, when the basic information and work history information of each of the plurality of workers are changed, the production plan establishment unit modifies the previously generated production plan.

6. The integrated vehicle production planning system of claim 1, wherein the production plan establishment unit calculates the expected hours required for the work of each worker according to a vehicle model or mounting option, and reflects the calculated worker's expected hours required for work to establish the overall vehicle production plan or to revise the previously generated production plan.

7. The integrated vehicle production planning system of claim 1, wherein the production plan establishment unit receives the basic information and work history information for each worker to calculate the expected hours required for the work for each worker through data mining.

8. The integrated vehicle production planning system of claim 1, wherein the information storage unit accumulates and stores the basic information and work history information of each of the plurality of workers through an enterprise resource planning (ERP) system, and the production plan establishment unit establishes the vehicle production plan by reflecting the expected hours required for the work through an advanced planning and scheduling (APS) system.

9. The integrated vehicle production planning system of claim 1, wherein, when vehicle production is completed according to the established vehicle production plan, the production plan establishment unit transmits the modified basic information and work history information of each of the plurality of workers after the completion.

10. An integrated vehicle production planning method comprising:
accumulating and storing basic information and work history information of each of a plurality of workers by an information storage unit;
establishing a vehicle production plan consisting of a type of work and a work sequence by a production plan establishment unit;
calculating an expected hours required for work for each worker of the plurality of workers based on the basic information and work history information of each worker of the information storage unit by the production plan establishment unit; and
establishing a vehicle production plan by reflecting the calculated expected hours required for work by the production plan establishment unit.

11. The integrated vehicle production planning method of claim 10, wherein after the establishing of the vehicle production plan by the production plan establishment unit, the method further comprises:
modifying a previously generated production plan when the basic information and work history information for each worker of the plurality of workers are changed.

12. The integrated vehicle production planning method of claim 11, wherein after the establishing of the vehicle production plan by the production plan establishment unit, the method further comprises:
transmitting the changed basic information and work history information for each worker of the plurality of workers to the information storage unit when the vehicle production is completed according to the established vehicle production plan.

13. The integrated vehicle production planning method of claim 10, wherein the calculating of the expected hours required for the work for each worker by the production plan establishment unit includes repeatedly establishing the vehicle production plan by the production plan establishment unit, and reflecting the expected hours required for the work for each worker updated every establishment of the vehicle production plan.
